(19) United States
(12) Patent Application Publication
(10) Pub. No.: US 2015/0305363 A1
(43) Pub. Date: Oct. 29, 2015

(54) OXIDATIVELY-STABILIZED FATS CONTAINING VERY LONG-CHAIN OMEGA-3 POLYUNSATURATED FATTY ACIDS AND USES THEREOF

(71) Applicant: CARGILL, INCORPORATED, Wayzata, MN (US)

(72) Inventors: Diliara IASSONOVA, Fort Collins, CO (US); Linsen LIU, Irvine, CA (US)

(21) Appl. No.: 14/647,172

(22) PCT Filed: Dec. 5, 2013
(86) PCT No.: PCT/US13/73263

§ 371 Date: May 26, 2015

Related U.S. Application Data
(60) Provisional application No. 61/733,692, filed on Dec. 5, 2012.

(51) Int. Cl. A23D 9/00

(52) U.S. Cl. CPC A23D 9/00

(57) ABSTRACT

The present disclosure provides food products including edible, non-hydrogenated fats with good oxidative stability despite elevated levels of very long chain omega-3 polyunsaturated fatty acids, e.g., EPA and DHA, from a vegetable oil.

### TECHNICAL FIELD

The present disclosure relates generally to edible fats and food products made with edible fats. More particularly, the present disclosure describes edible fats that are oxidatively stable even though they have elevated levels of oils containing very long chain omega-3 polyunsaturated fatty acids. Food products made with such fats exhibit surprisingly long shelf life.

### BACKGROUND

Consumers are paying increasing attention to not only the total fat content in food products, but also the nature of those fats. In general, foods low in saturated fats and trans-fats are viewed as healthier. Consumers also perceive some health benefits in increasing the levels of omega-3 fatty acids in one's diet.

Omega-3 fatty acids, also referred to as n-3 fatty acids, are unsaturated fatty acids having a carbon-carbon double bond in the third position. From a nutritional standpoint, the most important omega-3 fatty acids are probably α-linolenic acid (“ALA”), eicosapentaenoic acid (“EPA”), and docosahexaenoic acid (“DHA”). ALA is an 18-carbon fatty acid moiety having three carbon-carbon double bonds (commonly referred to as C18:3 in shorthand notation), one of which is at the n-3 position. EPA is a 20-carbon fatty acid moiety having 5 carbon-carbon double bonds (“C20:5”) and DHA is a 22-carbon fatty acid moiety having 6 carbon-carbon double bonds (“C22:6”).

Generally, the oxidative stability of a fatty acid decreases noticeably as the number of carbon-carbon double bonds, or the degree of unsaturation, increases. Unfortunately, ALA, EPA, and DHA are all polyunsaturated fats that tend to oxidize fairly readily. EPA (with 5 carbon-carbon double bonds) is significantly more prone to oxidation than ALA: DHA (with 6 carbon-carbon double bonds) is even more prone to oxidation than EPA. As a consequence, increasing the omega-3 content tends to reduce the shelf life of many food products. These problems become particularly acute with oils including significant amounts of EPA and DHA.

### DETAILED DESCRIPTION

### Overview

Specific details of several embodiments of the disclosure are described below. One aspect of the present disclosure is directed toward a food composition comprising an edible, non-hydrogenated fat having at least 1 wt % omega-3 fatty acids with a carbon chain length of twenty or greater and three or more carbon-carbon double bonds, no more than 10 wt % saturated fatty acids, and an Oxidative Stability Index (“OSI”) at 110° C. of at least 5 hours in the absence of added antioxidants, wherein the food composition comprises at least 16 mg of EPA plus DHA per FDA reference serving size of the food composition, and wherein the food composition has no material increase in an off-flavor or an off-aroma after storage at about 60° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, as determined by a trained sensory panel, in comparison to a control food composition that is formed in the same manner but without the 16 mg of EPA plus DHA. In some embodiments, the food composition may be a pasta, a cracker, a bar, or a ready-to-eat cereal. In some embodiments, the food composition comprises at least 32 mg of EPA plus DHA per FDA reference serving size of the food composition, and the food composition has no material increase in an off-flavor or an off-aroma after storage at about 60° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, as determined by a trained sensory panel, in comparison to a control food composition that is formed in the same manner but without the 32 mg of EPA plus DHA.

Another aspect of the disclosure provides a food composition comprising an edible, non-hydrogenated fat having at least 1 wt % omega-3 fatty acids with a carbon chain length of twenty or greater and three or more carbon-carbon double bonds, and an Oxidative Stability Index (“OSI”) at 110° C. of at least 37 hours. This fat includes a) a first fat including a rapeseed oil having at least about 65 wt % oleic acid; b) a second fat having at least 10 wt % of omega-3 fatty acids with a carbon chain length of twenty or greater and three or more carbon-carbon double bonds; and c) optionally an antioxidant, wherein the food composition comprises at least 16 mg of EPA plus DHA per FDA reference serving size of the food composition, and wherein the food composition has no material increase in an off-flavor or an off-aroma after storage at about 60° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, as determined by a trained sensory panel, in comparison to a control food composition that is formed in the same manner but without the 16 mg of EPA plus DHA. In some embodiments, the food composition may be a pasta, a cracker, a bar, or a ready-to-eat cereal. In some embodiments, the food composition comprises at least 32 mg of EPA plus DHA per FDA reference serving size of the food composition, and the food composition has no material increase in an off-flavor or an off-aroma after storage at about 60° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, as determined by a trained sensory panel, in comparison to a control food composition that is formed in the same manner but without the 32 mg of EPA plus DHA.

Another aspect of the disclosure provides a beverage comprising an edible, non-hydrogenated fat having at least 1 wt % omega-3 fatty acids with a carbon chain length of twenty or greater and three or more carbon-carbon double bonds, no more than 10 wt % saturated fatty acids, and an Oxidative Stability Index (“OSI”) at 110° C. of at least 5 hours in the absence of added antioxidants, wherein the food composition comprises at least 16 mg of EPA plus DHA per FDA reference serving size of the food composition, and wherein the food composition has no material increase in an off-flavor or an off-aroma after storage at about 4° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, or at least about 21 days, as determined by a trained sensory panel, in comparison to a control food composition that is formed in the same manner but without the 16 mg of EPA plus DHA. In some embodiments, the beverage composition may be a milk-based beverage, a nutritional supplement beverage, or a meal-replacement beverage. In some embodiments, the beverage composition comprises at least 32 mg of EPA plus DHA per FDA reference serving size of the food composition, and the beverage composition has no material increase in an off-flavor or an off-aroma after storage at about 4° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, at least about 13 days, at least about 14 days, at least about 15 days, at least about 16 days, at least about 17 days, at least about 18 days, at least about 19 days, at least about 20 days, or at least about 21 days, as determined by a trained sensory panel, in comparison to a control beverage composition that is formed in the same manner but without the 32 mg of EPA plus DHA.

Another aspect of the disclosure provides a beverage composition comprising an edible, non-hydrogenated fat having at least 1 wt % omega-3 fatty acids with a carbon chain length of twenty or greater and three or more carbon-carbon double bonds, and an Oxidative Stability Index (“OSI”) at 110° C. of at least 37 hours. This fat includes a) a first fat including a rapeseed oil having at least about 65 wt % oleic acid: b) a second fat having at least 9 wt % of omega-3 fatty acids with a carbon chain length of twenty or greater and three or more carbon-carbon double bonds; and c) optionally an antioxidant, wherein the beverage composition comprises at least 16 mg of EPA plus DHA per FDA reference serving size of the food composition, and wherein the beverage composition has no material increase in an off-flavor or an off-aroma after storage at about 4° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, at least about 13 days, at least about 14 days, at least about 15 days, at least about 16 days, at least about 17 days, at least about 18 days, at least about 19 days, at least about 20 days, or at least about 21 days, as determined by a trained sensory panel, in comparison to a control beverage composition that is formed in the same manner but without the 16 mg of EPA plus DHA. In some embodiments, the beverage composition may be a milk-based beverage, a nutritional supplement beverage, or a meal-replacement beverage. In some embodiments, the beverage composition comprises at least 32 mg of EPA plus DHA per FDA reference serving size of the beverage composition, and the beverage composition has no material increase in an off-flavor or an off-aroma after storage at about 4° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, at least about 13 days, at least about 14 days, at least about 15 days, at least about 16 days, at least about 17 days, at least about 18 days, at least about 19 days, at least about 20 days, or at least about 21 days, as determined by a trained sensory panel, in comparison to a control beverage composition that is formed in the same manner but without the 32 mg of EPA plus DHA.

Another aspect of the disclosure provides an edible baked food product formed by baking a composition at a temperature of at least 350° F. (177° C.) for at least 15 minutes. The product includes an edible, non-hydrogenated fat comprising a) a vegetable-sourced oil containing omega-3 fatty acids with a carbon chain length of twenty or greater and three or more carbon-carbon double bonds, and b) optionally an antioxidant. As used herein, the terms “vegetable oil” and “vegetable-sourced oil” include oil from oilseeds such as rapeseed or soybeans. The edible, non-hydrogenated fat has an Oxidative Stability Index (“OSI”) at 110° C. of at least 5 hours and at least 1 wt % omega-3 fatty acids with a carbon chain length of twenty or greater and three or more carbon-carbon double bonds. The edible baked food product comprises at least 16 mg of EPA plus DHA per FDA reference serving size of the food product, and has no material increase in an off-flavor or an off-aroma after storage at about 22° C. for at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 3 weeks, at least about one month, at least about 2 months, at least about 3 months, at least about 6 months, at least about 12 months, or at least about 18 months, as determined by a trained sensory panel, in comparison to a control food product that is formed in the same manner but without the 16 mg of EPA plus DHA. In some embodiments, the food product comprises at least 32 mg of EPA plus DHA per FDA reference serving size of the food composition, and the food composition has no material increase in an off-flavor or an off-aroma after storage at about 22° C. for at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 3 weeks, at least about one month, at least about 2 months, at least about 3 months, at least about 6 months, at least about 12 months, or at least about 18 months, as determined by a trained sensory panel, in comparison to a control food product that is formed in the same manner but without the 32 mg of EPA plus DHA.

Another aspect of the disclosure provides an edible baked food product formed by baking a composition at a temperature of at least 350° F. (177° C.) for at least 15 minutes. The composition includes an edible, non-hydrogenated fat comprising a) a rapeseed oil having at least 65 weight percent (“wt %”) oleic acid, b) a vegetable-sourced oil containing omega-3 fatty acids with a carbon chain length of twenty or greater and three or more carbon-carbon double bonds, and c) optionally an antioxidant. The edible, non-hydrogenated fat has an Oxidative Stability Index (“OSI”) at 110° C. of at least 37 hours and at least 1 wt % omega-3 fatty acids with a carbon chain length of twenty or greater and three or more carbon-carbon double bonds. The edible baked food product comprises at least 16 mg of EPA plus DHA per FDA reference serving size of the food product, and has no material increase in an off-flavor or an off-aroma after storage at about 22° C. for at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 3 weeks, at least about one month, at least about 2 months, at least about 3 months, at least about 6 months, at least about 12 months, or at least about 18 months, as determined by a trained sensory panel, in comparison to a control food product that is formed in the same manner but without the 16 mg of EPA plus DHA. In some embodiments, the food product comprises at least 32 mg of EPA plus DHA per FDA reference serving size of the food product, and the food product has no material increase in an off-flavor or an off-aroma after storage at about 22° C. for at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 3 weeks, at least about one month, at least about 2 months, at least about 3 months, at least about 6 months, at least about 12 months, or at least about 18 months, as determined by a trained sensory panel, in comparison to a control food product that is formed in the same manner but without the 32 mg of EPA plus DHA.

A method of making an edible baked food product in accordance with a further aspect of the disclosure includes mixing a composition comprising a first food ingredient, which may be flour, and an edible, non-hydrogenated fat and baking the composition at a temperature of at least 350° F. (177° C.) for at least 15 minutes. In one embodiment, the edible, non-hydrogenated fat includes a) a vegetable-sourced oil containing omega-3 fatty acids with a carbon chain length of twenty or greater and three or more carbon-carbon double bonds, and b) optionally an antioxidant. In some embodiments, the edible, non-hydrogenated fat has an Oxidative Stability Index (“OSI”) at 110° C. of at least 5 hours and at least 1 wt % omega-3 fatty acids with a carbon chain length of twenty or greater and three or more carbon-carbon double bonds. In another embodiment, the edible, non-hydrogenated fat includes a) a rapeseed oil having at least 65 weight percent (“wt %”) oleic acid, b) a vegetable-sourced oil containing omega-3 fatty acids with a carbon chain length of twenty or greater and three or more carbon-carbon double bonds, and c) optionally an antioxidant. In some embodiments, the edible, non-hydrogenated fat has an Oxidative Stability Index (“OSI”) at 110° C. of at least 37 hours and at least 1 wt % omega-3 fatty acids with a carbon chain length of twenty or greater and three or more carbon-carbon double bonds. The edible baked food product comprises at least 16 mg of EPA plus DHA per FDA reference serving size of the food product, and has no material increase in an off-flavor or an off-aroma after storage at about 22° C. for at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 3 weeks, at least about one month, at least about 2 months, at least about 3 months, at least about 6 months, at least about 12 months, or at least about 18 months, as determined by a trained sensory panel, in comparison to a control food product that is formed in the same manner but without the 16 mg of EPA plus DHA. In some embodiments, the food product comprises at least 32 mg of EPA plus DHA per FDA reference serving size of the food product, and the food product has no material increase in an off-flavor or an off-aroma after storage at about 22° C. for at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 3 weeks, at least about one month, at least about 2 months, at least about 3 months, at least about 6 months, at least about 12 months, or at least about 18 months, as determined by a trained sensory panel, in comparison to a control food product that is formed in the same manner but without the 32 mg of EPA plus DHA.

Unless otherwise indicated, all numbers expressing quantities of ingredients, properties such as molecular weight, percentages, reaction conditions, and so forth used in the specification and claims are to be understood as being modified by the term “about.” Accordingly, unless indicated to the contrary, the numerical parameters set forth are approximations that may depend upon the desired properties sought.

### Edible Fats—Components

Embodiments of the disclosed edible fats include a first fat, which in some embodiments has at least 63 wt % oleic acid; a second fat that includes very long chain omega-3 polyunsaturated fatty acid (i.e., omega-3 polyunsaturated fatty acid having a carbon chain length of twenty or greater): and, optionally, an antioxidant. Suitable components are described below.

### A. High Oleic Acid First Fat

The first fat is an edible fat and may be relatively high in oleic acid, typically including at least 63 wt % oleic acid, a monounsaturated 18-carbon acid moiety commonly referred to as C18:1. In select embodiments, the first fat includes at least 65 wt %, e.g., 67 wt % or more, oleic acid, with select implementations including at least 70 wt %, e.g., 73 wt % or more, 75 wt % or more, 80 wt % or more, 82 wt % or more, or 84 wt % or more, oleic acid.

In the compositions described herein, the stated fatty acid percentages are based on the total weight of fatty acids in the fat and may be determined using AOCS Official Method Ce 1i-07. In the Examples set forth below, unless otherwise indicated, the fats are analyzed via a gas chromatograph determination of fatty acid profile per the American Oil Chemist's Society Official Method Ce 1i-07, modified as spelled out below in connection with the Examples.

The first fat may also be relatively low in saturated fatty acids, in some embodiments comprising no more than 12 wt % saturated fatty acids. For example, the first fat may contain 10 wt % or less, e.g., 9 wt % or less, 7 wt % or less, no more than 5 wt %, or no more than 4.5 wt %, or no more than 4 wt %, saturated fatty acids. Use of a first fat with lower saturated fatty acid content can reduce the total amount of saturated fat in the edible fat composition, particularly if the edible fat composition includes more of the first fat than the second fat. Although the first fat may be partially hydrogenated, a non-hydrogenated oil is preferred for many applications as it will limit the content of both saturated fat and trans-fats. As noted above, lower total saturated fat and trans-fat contents have positive health connotations in consumers' minds. For other food applications that require a structured fat, it may be advantageous to include a hydrogenated or partially hydrogenated oil.

If so desired, the first fat may be relatively low in ALA. In some embodiments, the first fat comprises no more than 5.0 wt % ALA, e.g., no more than 4.0 wt % or no more than 3.5 wt % ALA, with some useful embodiments employing a first fat having no more than 3.0 wt % ALA, no more than 2 wt % ALA, no more than 2.5 wt % ALA, or no more than 1 wt % ALA. In other embodiments, however, the first fat may have higher levels of ALA to further increase the total omega-3 fatty acid content of the edible fat composition.

In some implementations, the first fat desirably has no more than 20 wt %, preferably no more than 18 wt %, e.g., 15 wt % or less, linoleic acid, which is an 18-carbon acid moiety with two carbon-carbon double bonds commonly referred to as C18:2. In some embodiments, the first fat includes no more than 12 wt % linoleic acid, no more than 10 wt % linoleic acid, or no more than 9 wt % linoleic acid.

The first fat may be free, or at least substantially free (e.g., no more than 0.1 wt %), of omega-3 polyunsaturated fatty acids having more than 18 carbon atoms and more than two carbon-carbon double bonds. It is anticipated that the first fat will be free of both EPA and DHA.

Although the first fat may come from a variety of fat sources, e.g., algal oils, in one embodiment the first fat is, or at least includes, a vegetable oil. Typically this oil will be commercially refined, bleached, and deodorized, though a less-processed oil, such as an expelled oil or a cold-pressed oil, may be used. In a preferred embodiment, the first fat is rapeseed oil, which encompasses what is commonly called “canola” oil in North America. Suitable rapeseed oils meeting the above-specified criteria are commercially available from Cargill, Incorporated of Wayzata, Minn., USA under the CLEAR VALLEY® trademark, such as CLEAR VALLEY 65-brand (“CV65”), CLEAR VALLEY 75-brand (“CV75”), or CLEAR VALLEY 80-brand (“CV80”) canola oils. High-oleic sunflower oil (e.g., CLEAR VALLEY brand) having at least about 65 wt % oleic acid and high-oleic, low-linolenic soybean oil may also suffice for some specific applications.

### B. VLC Omega-3 PUFA-Containing Second Fat

Edible fats disclosed herein may employ a second fat, which preferably is both edible and non-hydrogenated, that serves as a source for very long chain omega-3 polyunsaturated fatty acid content. As used herein, “very long chain omega-3 polyunsaturated fatty acid” and “VLC omega-3 PUFA” refer to a long chain polyunsaturated omega-3 fatty acid with a carbon chain length of 20 or greater and 3 or more carbon-carbon double bonds. Such fatty acids include, but are not limited to, EPA, DHA, and DPA; “DPA” refers to the omega-3 isomer of docosapentaenoic acid (also known as clupanodonic acid), which is a 22-carbon fatty acid moiety having 5 carbon-carbon double bonds (C22:5n-3). The term “VLC omega-3 PUFA” encompasses both a single type of fatty acid (e.g., EPA or DHA) and multiple types of fatty acids (e.g., EPA and DHA) where used below unless context requires otherwise.

The second fat can have at least 5 wt % VLC: omega-3 PUFA, at least 6 wt %, at least 7 wt %, at least 8 wt %, at least 9 wt %, or desirably at least 10 wt % VLC omega-3 PUFA. In some preferred embodiments, the second fat includes at least 13 wt %, at least 15 wt %, at least 16 wt %, at least 22 wt %, at least 30 wt %, or at least 36 wt %, e.g., 20-45 wt %, VLC omega-3 PUFA. Edible fats known to have such high VLC omega-3 PUFA contents include those derived from specific animals, especially marine animals, specific algae, and fermentation. In some embodiments, the edible fat including VLC omega-3 PUFAs may be derived from a vegetable source, such as, for example, rapeseed that has been modified to produce VLC omega-3 PUFAs. Methods of preparing rapeseed that has been modified to produce VLC omega-3 PUFAs are known to those of skill in the relevant arts and are described, for example, in U.S. Pat. No. 7,544,859 (Heinz et al.). U.S. patent application Ser. No. 10/566,944 (Zank et al.), U.S. Pat. No. 7,777,098 (Cirpus et al.), U.S. patent application Ser. No. 12/768,227 (Cirpus et al.), U.S. patent application Ser. No. 10/590,457 (Cirpus et al.), U.S. Pat. No. 8,049,064 (Cirpus et al.), Ser. No. 12/438,373 (Bauer et al.), and International Patent Application No. PCT/CA2007/(001218 (Meesaptodsuk et al.), the entireties of which are incorporated herein by reference.

Oils containing VLC omega-3 PUFA are notoriously oxidatively unstable and for that reason, may be sold in encapsulated form. As noted below, however, aspects of this disclosure provide edible fats that have excellent oxidative stability without the complexity and expense of encapsulation. Accordingly, it is preferred that the second fat be in bulk form instead of encapsulated.

The second fat may contain one specific type of VLC omega-3 PUFA, e.g., DHA or EPA. In one useful embodiment, however, the second fat includes both EPA and DHA. In some embodiments, the second fat including both EPA and DHA may be derived from a vegetable-sourced oil, such as, for example, a rapeseed oil. In some embodiments, the rapeseed oil is a canola oil that includes at least 2 wt %, at least 3 wt %, at least 4 wt %, at least 5 wt %, at least 6 wt %, at least 7 wt %, at least 8 wt %, at least 9 wt %, at least 10 wt %, at least 13 wt %, at least 15 wt %, or at least 20 wt % VLC Omega-3 PUFAs. In some embodiments, the canola oil includes less than 30 wt %, less than 28 wt %, less than 26 wt %, less than 24 wt %, less than 22 wt/o, less than 20 wt %, less than 18 wt %/o, or less than 16 wt % VLC Omega-3 PUFAs. In some embodiments, the canola oil includes 2 wt % to 30 wt %, 3 wt % to 28 wt %, 5 wt % to 26 wt %, 7 wt % to 24 wt %, 8 wt % to 22 wt %, 8.5 wt % to 20 wt %, 9 wt % to 18 wt %, or 9.5 wt % to 16 wt % VLC Omega-3 PUFAs. In some embodiments, such canola oil includes at least 2 wt %, at least 3 wt %, at least 4 wt %, at least 5 wt %, at least 6 wt %, at least 7 wt %, at least 8 wt %, at least 9 wt %, at least 10 wt %, at least 13 wt %, at least 15 wt %, or at least 20 wt % combined DHA and EPA. In some embodiments, the canola oil includes less than 30 wt %, less than 28 wt %, less than 26 wt %, less than 24 wt %, less than 22 wt %, less than 20 wt %, less than 18 wt %, or less than 16 wt % combined DHA and EPA. In some embodiments, the canola oil includes 2 wt % to 30 wt %, 3 wt % to 28 wt %, 5 wt % to 26 wt %, 7 wt % to 24 wt %, 8 wt % to 22 wt %, 8.5 wt % to 20 wt %, 9 wt % to 18 wt %, or 9.5 wt % to 16 wt % combined DHA and EPA.

The conventional commercial processes of refining, bleaching, and deodorizing can be deleterious to fats that contain VLC omega-3 PUFA, promoting oxidation of the polyunsaturated fat. Accordingly, it may be advantageous to employ a second fat that is an expelled oil, a cold-pressed oil, or a solvent-extracted oil that has not been subjected to the full commercial refining, bleaching, and deodorizing process.

### C. Antioxidant

Edible fats of this disclosure optionally include at least one antioxidant. Any of a wide range of antioxidants recognized for use in fats and other foods are expected to work well, including but not limited to tertiary-butylhydroquinone (“TBHQ”), butylhydroxyanisole (“BHA”), butylhydroxytoluene (“BHT”), propyl gallate (“PG”), vitamin E and other tocopherols, rosemary oil, rosemary extract, green tea extract, ascorbic acid, ascorbyl palmitate, or selected polyamines (see, e.g., U.S. Pat. No. 6,428,461 and Shahidi, Fereidoon, ed. Bailey's Industrial Oil and Fat Products. Sixth ed. Vol. 1. John Wiley & Sons, 2005, the entireties of which are incorporated herein by reference). Such antioxidants may be used alone or in combination. One rosemary oil-based antioxidant is commercially available from Kalsec, Inc. of Kalamazoo, Mich., USA under the trade name DURALOX. In one implementation that has been found to work well, the antioxidant comprises TBHQ. Rosemary extracts and green tea extracts that may be used in embodiments of the present disclosure are available under the trade name GUARDIAN and are available from Danisco, Copenhagen, Denmark.

As used herein, the term “maximum antioxidant content” (“Max. AO”) refers to the maximum amount (weight percent) of an antioxidant allowed in a food product by the FDA in 21 CFR as of 1 Sep. 2009 that preferably has no material adverse sensory impact on the food product to which it is added. In some embodiments, the Max. AO of BHA, TBHQ, BHT, or PG in the edible fat may be 200 ppm; lesser levels, e.g., 150 ppm, or 100 ppm, are also expected to work well. In some embodiments, the Max. AO of rosemary extracts or green tea extracts in the edible fat may be less than 5,000 ppm; lesser levels, e.g., less than 4,000 ppm, less than 3,000 ppm, less than 2,000 ppm, or less than 1,000 ppm, are also expected to work well.

### Edible Fats—Properties

### A. Generally

Edible fats in accordance with aspects of this disclosure may include at least 1 wt %, preferably at least 1.5 wt %, VLC omega-3 PUFA. Desirably, the edible fats have a VLC omega-3 PUFA content of at least 2 wt %, e.g., at least 2.5 wt %, and preferably at least 3 wt % or at least 3.5 wt %. Some preferred embodiments may have 0.55-7 wt %, e.g., 1-5 wt %, 1-4 wt %, or 1.5-3.5 wt %, VLC omega-3 PUFA.

The amount of VLC omega-3 PUFA in the edible fat will depend in part on the nature and relative percentages of the first and second fats, with VLC omega-3 PUFA content increasing as the amount of the second fat is increased. The precise combination of first and second fats and the resultant VLC omega-3 PUFA content useful in any given application will depend on a variety of factors, including desired shelf life, flavor profile, and the type of food application for which the edible fat is intended. With the present disclosure in hand, though, those skilled in the art should be able to select suitable combinations of the identified first and second fats for a particular application.

As explained previously, saturated fats and trans-fats have negative health connotations. Certain edible fats of the disclosure, therefore, may have relatively low levels of such fats. For example, some useful implementations have less than 12 wt % saturated fat, preferably no more than 10 wt %, e.g., no more than 9 wt % or no more than 8 wt %, saturated fat.

In certain applications, the edible fat may have less than 7 wt %, desirably less than 5 wt %, saturated fat. Although most commercially-refined, bleached, and deodorized vegetable oils will contain some minor level of trans-fat, the edible fat desirably includes no more than 3.5 wt % trans-fat, preferably no more than 3 wt %, e.g., 0-2 wt %, trans-fat.

In some implementations, the edible fat may be a structured fat that is solid or semi-solid at room temperature. In other applications, however, the edible fat is pourable at room temperature. For example, the oil may have a solid fat content (determined in accordance with AOCS Cd 16b-93) of no more than 20%, e.g., no more than 12% or no more than 10%, at 10° C.

### B. Oxidative Stability

Oxidative stability depends on many factors and cannot be determined by fatty acid profile alone. It is generally understood, though, that VLC omega-3 PUFA tend to oxidize more readily than oleic acid and other more saturated fatty acids. On a relative oxidative stability scale, linoleic acid is significantly more stable than VLC omega-3 PUFA, oleic acid is significantly more stable than linoleic acid, and saturated fatty acids are even more stable than oleic acid.

Edible fats of this disclosure exhibit notably high oxidative stability despite their relatively high VLC omega-3 PUFA levels. Particularly surprising is that these high oxidative stabilities have been achieved without increasing saturated fat contents to unacceptable levels in an effort to compensate for the increased VLC omega-3 PUFA content. European Patent No. 1 755 409, for example, specifically teaches that liquid oils are undesirable for use with Martek's DHA-containing algal oil, instead saying that one should use such oil with highly-saturated tropical fats, such as palm oil and palm kernel oil.

Oxidative stability can be measured in a variety of ways. As used herein, though, oxidative stability is measured as an Oxidative Stability index, or OSI, at 80° C. and 110° C., as spelled out below in connection with the Examples. It is worth noting that the temperature at which the OSI test is conducted can significantly impact the measurements, with OSI measurements being significantly lower at higher temperatures. See, for example, Garcia-Moreno, et al., “Measuring the Oxidative Stability of Fish Oil By the Rancimat Test” from the proceedings of Food Innova 2010, Oct. 25-29, 2010, Valencia, Spain, which suggests that a 30° C. increase from 60° C. to 90° C., with all other factors remaining the same, can drive the OSI measurement for fish oil from 18 hours down to less than 2 hours.

In some embodiments, edible fats of this disclosure may exhibit an OSI value at 110° C. of greater than 35 hours, e.g., at least 37 hours, greater than 40 hours, greater than 50 hours, greater than 60 hours, or greater than 69 hours.

### C. Select Embodiments

In one commercially-useful aspect of the present disclosure, the first fat is rapeseed oil and the second fat is vegetable-sourced oil, preferably a rapeseed oil containing VLC Omega-3 PUFAs. More specifically, the rapeseed oil may comprise refined, bleached, and deodorized canola oil derived from Brassica napus seeds and may contain at least 65 wt % oleic acid, no more than 4 wt % ALA, and no more than 20 wt % linoleic acid. The vegetable-sourced oil is desirably food grade and contains at least 2.5 wt %, e.g., 10 wt % or 15-35 wt %, VLC omega-3 PUFA.

The edible fat desirably includes between 50 wt % and 97 wt %, e.g., 75-96 wt % or 80-96 wt %, of the rapeseed oil and between 3 wt % and 50 wt %, e.g., 4-25 wt % or 4-20 wt %, vegetable-sourced oil containing VLC Omega-3 PUFAs. With the addition of antioxidants, such blends have yielded OSI values greater than 35 hours, e.g., at least 37 hours, with many such blends exceeding 40 hours and some exceeding 50 hours, 60 hours, or even 69 hours.

### Food Products

Aspects of this disclosure allow formulation of food products with relatively high levels of VLC omega-3 PUFA without unduly sacrificing shelf life. In one implementation, food products of the disclosure contain at least 16 mg of VLC omega-3 PUFA (preferably DHA and/or EPA), desirably at least 32 mg of VLC omega-3 PUFA (preferably DHA and/or EPA), per 50 g of the food product. In some embodiments, the food product may be a bread, a muffin, a pasta, a cracker, a bar, or a ready-to-eat cereal. In some embodiments, the edible fat may be added to a milk-based beverage (e.g., a beverage including a whole milk, a 2% milk, a 1% milk, or a skimmed milk), a nutritional supplement beverage, or a meal-replacement beverage. In some embodiments, the milk-based beverage may be a flavored milk-based, beverage, such as, for example, a chocolate-flavored milk-based beverage, a strawberry-flavored milk-based beverage, a banana-flavored milk-based beverage, an orange-flavored milk-based beverage, a vanilla-flavored milk-based beverage, a caramel-flavored milk-based beverage, or a coffee-flavored milk-based beverage.

Some embodiments provide food products comprising edible fats in accordance with the preceding discussion. The edible fat may be incorporated in the food product in any conventional fashion. For example, the food product may comprise a fried food (e.g., French fries or donuts) fried in the edible fat.

In other instances, the edible fat may be mixed with other ingredients of the food product prior to cooking, e.g., to supply some or all of the fat requirements for a batter or the like for a baked food product. Edible fats in accordance with the disclosure appear to be very useful in food products that are cooked with the edible fat included, e.g., by incorporating the edible fat in an uncooked product then cooking to produce the final food product. In baked goods, for example, uncooked product may be a batter or dough (e.g., a bread dough) that incorporates the edible fat and the uncooked product may be cooked at a temperature of at least 350° F. (e.g., at least 375° F. or at least 400° F.) for at least 10 minutes (e.g., at least 15 minutes, at least 20 minutes, or at least 30 minutes). Edible fats in accordance with this disclosure are expected to withstand the challenging environment of such cooking to provide cooked food products, including baked food products, with both elevated VLC omega-3 PUFA contents and commercially-desirable stability, and shelf life.

In still other instances, the edible fat may be an ingredient in a food product or a component thereof that does not need to be cooked. In such applications, the edible fat is not subject to the rigors of high-temperature processing. In one such application, the edible fat may be used as a bakery shortening (e.g., a liquid shortening or as a component in a solid or semi-solid shortening) for use in fillings, icings, or the like. In another such application, the edible fat may be sprayed on the food product as a coating, e.g., as a coating applied to crackers, chips, pretzels, cereal products (e.g., ready-to-eat cereals or cereal bars), nuts, or dried fruits. In some embodiments, the edible fat may be added to a milk-based beverage (e.g., a beverage including a whole milk, a 2% milk, a 1% milk, or a skimmed milk), a nutritional supplement beverage, or a meal-replacement beverage. In some embodiments, the milk-based beverage may be a flavored milk-based, beverage, such as, for example, a chocolate-flavored milk-based beverage, a strawberry-flavored milk-based beverage, a banana-flavored milk-based beverage, an orange-flavored milk-based beverage, a vanilla-flavored milk-based beverage, a caramel-flavored milk-based beverage, or a coffee-flavored milk-based beverage.

Knowing the desired fat content of a given food product, the composition of the edible fat may be adjusted to yield a desired VLC omega-3 PUFA content in the food product. For example, the U.S. Food and Drug Administration allows food manufacturers to identify a food product as a “good” source of omega-3 fatty acids if it contains at least 16 mg of EPA plus DHA (i.e., the combined weights of EPA and DHA) per serving and as an “excellent” source if it contains at least 32 mg of EPA plus DHA per serving. In one embodiment, food products of the invention may meet one or both of these criteria without unduly impacting shelf life.

The US FDA sets a “reference amount” for determining an appropriate serving size for a given food product in the U.S., with the reference amount varying from one type of food product to another. As used herein, the term FDA Reference Serving Size for a given food product is the “reference amount” set forth in 21 CFR §101.12 as of 1 Sep. 2009. For example, the FDA Reference Serving Size for grain-based bars such as granola bars is 40 g, for prepared French fries is 70 g, and for snack crackers is 30 g.

By way of example, a food manufacturer may intend to produce a grain-based bar. If the bar includes 1 g of the present edible fat per 40 g FDA Reference Serving Size, an edible fat having 1.65 wt % EPA plus DHA (e.g., sample A4 in Example 1 below) would contribute 16.5 mg of EPA plus DHA per serving, permitting the “good source” designation on the packaging for the bar. If the bar instead includes 2 g of the same edible fat per serving, the bar could be designated as an “excellent source” of EPA plus DHA. Similarly, a bar could be labeled as a “good source” of EPA plus DHA if it contains 1.5 g of an edible fat of the disclosure having 1.1 wt % EPA plus DHA (e.g., sample A3 in Example 1 below) per serving. With the oxidative stabilities of the present edible fats, such food products should have excellent shelf lives despite their high VLC omega-3 PUFA contents.

### Shelf Life

In some embodiments, food products comprising edible fats in accordance with the preceding discussion and at least 16 mg of EPA plus DHA per FDA reference serving size of the food product are provided, where the food products include has no material increase in an off-flavor or an off-aroma after storage at about 60° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, as determined by a trained sensory panel, in comparison to a control food product that is formed in the same manner but without the edible fats in accordance with the preceding discussion.

In some embodiments, food products comprising edible fats in accordance with the preceding discussion and at least 16 mg of EPA plus DHIA per FDA reference serving size of the food product are provided, where the food products include has no material increase in an off-flavor or an off-aroma after storage at about 4° C. for at least about 6 hours, at least about 12 hours, at least about 18 hours, at least about 24 hours, at least about 2 days, at least about 3 days, at least about 4 days, at least about 5 days, at least about 6 days, at least about 7 days, at least about 8 days, at least about 9 days, at least about 10 days, at least about 11 days, or at least about 12 days, at least about 13 days, at least about 14 days, at least about 15 days, at least about 16 days, at least about 17 days, at least about 18 days, at least about 19 days, at least about 20 days, or at least about 21 days, as determined by a trained sensory panel, in comparison to a control food product that is formed in the same manner but without the edible fats in accordance with the preceding discussion.

Testing has demonstrated that food products produced in accordance with embodiments of the present disclosure have no material increase in an off-aroma in comparison to a control food product that is formed in the same manner but without 16 mg of EPA plus DHA per FDA reference serving size of the food product or without 32 mg of EPA plus DHA per FDA reference serving size of the food product.

In particular, aroma testing by trained test panels has demonstrated that food products with an edible fat component in accordance with aspects of the present disclosure reliably yield a food product lacking off-aroma. Surprisingly, this sensory analysis did not note any material increase in fishy, painty, earthy, rancid, or oxidized aromas of the type commonly associated with some oils, including EPA and DHA.

### EXAMPLES

### Experimental Procedures

The following experimental examples utilize several test protocols:

Oxidative Stability Index (“OSI”): The OSI measurements were carried out in accordance with AOCS Cd 12b-92 at 80° C. and 110° C. as indicated with a 743 RANCIMAT analyzer (Metrohm AG, Herisau, Switzerland) generally in accordance with American Oil Chemists' Society test protocol AOCS Cd 12b-92, except that the sample size of the oil is 3.0 g.

Fatty acid profile (wt %) determination: In accordance with American Oil Chemist's Society Official Method AOCS Ce 1i-07, the oil is treated to convert acylglycerols to fatty acid methyl esters (“FAMEs”) and vials of the FAMEs are placed in a gas chromatograph for analysis in accordance with American Oil Chemist's Society Official Method AOCS Ce 1i-07. This modified chromatography employs an Agilent 7890A gas chromatograph (Agilent Technologies, Santa Clara, Calif.) equipped with a fused silica capillary column (30 m×0.25 mm and 0.25 μm film thickness) packed with a polyethylene glycol based DB-WAX for liquid phase separation (J&W Scientific, Folsom, Calif.). Hydrogen (H₂) is used as the carrier gas at a flow rate of 1.2 mL/min and the column initial temperature is 170° C., ramp 1° C./min, final temperature is 225° C.

Schaal Oven Test (AOCS Cg 5-97): The fat is placed in amber glass bottles and the bottles are stored, open to ambient air, in an electrically heated convection oven held at 60° C. The oil is periodically assessed, e.g., by measuring peroxide values and/or conducting sensory testing. This method is commonly referred to as the “Schaal Oven” method and is widely used as an accelerated aging test of shelf stability for oil substrates.

Peroxide Value: Conducted in accordance with American Oil Chemist's Society Official Method AOCS Cd 8b-90.

### Example 1

### OSI of Oils at 80° C. and 110° C.

CLEAR VALLEY 80-brand canola oil (“CV80” in Table 1A) (Cargill, Incorporated, Wayzata, Minn. USA) and a canola oil including 10 wt % combined DHA, EPA, and DPA (“DHA/EPA canola 10 oil” in Table 1A) were subjected to OSI testing at 80° C. and at 110° C. at as set forth above. The OSI value at 80° C. and at 110° C. for each of the samples was measured without any added antioxidants. The results of the OSI tests are set forth in Table 1A.

TABLE 1A
OSI Test Results at 80° C. and at 110° C.

| | | |
|---|---|---|
| SAMPLE | Temperature | OSI (Hours) |

| | | |
|---|---|---|
| CV80 | 80° C. | >100 |
| CV80 | 80° C. | >100 |
| CV80 | 110° C. | 20.37 |
| CV80 | 110° C. | 19.94 |
| DHA/EPA | 80° C. | 46.54 |
| Canola 10 oil | | |
| DHA/EPA | 80° C. | 52.47 |
| Canola 10 oil | | |
| DHA/EPA | 110° C. | 5.23 |
| Canola 10 oil | | |
| DHA/EPA | 110° C. | 5.22 |
| Canola 10 oil | | |

These results show that the OSI values for the canola oils tested are about ten times higher at 80° C. than at 110° C. DHA/EPA canola 10 oil can be stabilized with specialty canola oil (e.g., CLEAR VALLEY-80) and/or by the addition of antioxidants known to those skilled in the relevant arts.

### Example 2

### OSI of Oils with Antioxidants at 110° C.

Materials:

CLEAR VALLEY 80-brand canola oil (“CV80”) (Cargill, Incorporated, Wayzata, Minn., USA), canola oil (“Canola”) (Cargill, Incorporated, Wayzata. Minn., USA), GUARDIAN Rosemary Extract 08 (Danisco. Copenhagen, Denmark), GUARDIAN Rosemary Extract 12 (Danisco, Copenhagen, Denmark), GUARDIAN Rosemary Extract 221 (Danisco, Copenhagen, Denmark), GUARDIAN Green Tea Extract 20M (Danisco, Copenhagen, Denmark), and GUARDIAN Green Tea Extract 20S (Danisco, Copenhagen, Denmark).

CV80, and Canola are combined with antioxidant to provide oil samples having an antioxidant concentration of 1,000 ppm or 2,000 ppm (Table 2). The “Control” for each oil sample does not include added antioxidant.

OSI testing at 110° C. was performed on each of the samples at as set forth above. The results of the OSI tests are set forth in Table 2.

TABLE 2
OSI of Oils with Antioxidants at 110° C.

| | OSI |
|---|---|
| Sample | (Hours) |
| CV80 (Control) | 22.35 |
| CV80 + GUARDIAN Rosemary Extract 08 | 32.69 |
| (2000 ppm) | |
| CV80 + GUARDIAN Rosemary Extract 12 | 25.53 |
| (2000 ppm) | |
| CV80 + GUARDIAN Rosemary Extract 221 | 32.63 |
| (2000 ppm) | |
| CV80 + GUARDIAN Green Tea Extract 20M | 48.69 |
| (1000 ppm) | |
| CV80 + GUARDIAN Green Tea Extract 20S | 54.36 |
| (1000 ppm) | |
| Canola (Control) | 9.92 |
| Canola + GUARDIAN Rosemary Extract 08 | 14.81 |
| (2000 ppm) | |
| Canola + GUARDIAN Rosemary Extract 12 | 11.59 |
| (2000 ppm) | |
| Canola + GUARDIAN Rosemary Extract 221 | 15.48 |
| (2000 ppm) | |
| Canola + GUARDIAN Green Tea Extract 20M | 21.04 |
| (1000 ppm) | |
| Canola + GUARDIAN Green Tea Extract 20S | 24.41 |
| (1000 ppm) | |

These results show that the OSI values for the oils tested are higher when either a rosemary extract or a green tea extract is added to the oil.

### Example 3

### Fatty Acid Profiles and OSI Values of Oils

Materials:

CLEAR VALLEY 80-brand canola oil (“CV80”) (Cargill, Incorporated, Wayzata, Minn., USA), a canola oil including about 10 wt % combined DHA, EPA, and DPA (“DHA/EPA canola 10”), and a canola oil including about 13 wt % combined DHA, EPA, and DPA (“DHA/EPA canola 13”).

The fatty acid profiles of oils used in this Example were measured using the modified the AOCS Ce 1i-07 protocol noted above. Table 3A sets forth the measured wt % for each of the identified fatty acids.

TABLE 3A
Fatty Acid Profile of Oils

| | | | | DHA/EPA |
|---|---|---|---|---|
| | | | DHA/EPA | Canola |
| | | | Canola 10:CV80 | 13:CV80 |
| | DHA/EPA | DHA/EPA | (50:50 | (50:50 |
| Fatty Acid | Canola 13 | Canola 10 | Blend) | Blend) |
| C8:0 | 0.00 | 0.00 | 0.00 | 0.00 |
| C9:0 | 0.00 | 0.00 | 0.00 | 0.00 |
| C10:0 | 0.00 | 0.00 | 0.00 | 0.00 |
| C11:0 | 0.00 | 0.00 | 0.00 | 0.00 |
| C12:0 | 0.00 | 0.00 | 0.00 | 0.00 |
| C11:1 | 0.00 | 0.00 | 0.00 | 0.00 |
| C13:0 | 0.00 | 0.00 | 0.00 | 0.00 |
| C12:1 | 0.00 | 0.00 | 0.00 | 0.00 |
| C14:0 | 0.06 | 0.06 | 0.05 | 0.05 |
| C13:1 | 0.00 | 0.00 | 0.00 | 0.00 |
| C14:1 + 15:0 | 0.00 | 0.04 | 0.03 | 0.02 |
| C16:0 | 4.61 | 4.81 | 4.06 | 3.96 |
| C16:1 | 0.11 | 0.21 | 0.21 | 0.16 |
| C17:0 | 0.00 | 0.00 | 0.03 | 0.05 |
| C18:0 | 3.14 | 1.96 | 2.00 | 2.60 |
| C18:1 Oleate | 23.28 | 28.36 | 52.73 | 50.50 |
| C18:1 | 2.10 | 3.34 | 0.09 | 0.10 |
| Vaccenate | | | | |
| C18:2 | 31.15 | 30.64 | 19.63 | 19.94 |
| C20:0 | 0.82 | 0.58 | 0.65 | 0.78 |
| C18:3 Gamma | 1.57 | 1.05 | 0.53 | 0.74 |
| C20:1 | 0.81 | 0.83 | 1.14 | 1.14 |
| C18:3 Alpha | 4.38 | 7.42 | 4.84 | 3.33 |
| Lin | | | | |
| C20:2 | 0.86 | 0.74 | 0.39 | 0.45 |
| C22:0 | 0.36 | 0.30 | 0.35 | 0.38 |
| C20:3 Homo | 3.01 | 1.36 | 0.68 | 1.49 |
| Lin | | | | |
| C22:1 | 0.00 | 0.00 | 0.00 | 0.00 |
| C18:3 11-14-17 | 0.32 | 0.26 | 0.10 | 0.15 |
| C20:4 | 5.17 | 4.19 | 2.13 | 2.49 |
| C23:0 | 0.00 | 0.00 | 0.00 | 0.00 |
| C22:2 | 0.00 | 0.10 | 0.00 | 0.00 |
| C20:5 (EPA) | 8.42 | 5.88 | 3.03 | 4.06 |
| C24:0 | 0.00 | 0.12 | 0.20 | 0.15 |
| C22:3 | 0.00 | 0.00 | 0.00 | 0.18 |
| C24:1 | 0.00 | 0.11 | 0.00 | 0.00 |
| C22:4 | 0.97 | 0.78 | 0.35 | 0.50 |
| C22:5N3 (DPA) | 3.06 | 3.26 | 1.59 | 1.57 |
| C22:6 (DHA) | 1.72 | 1.25 | 0.74 | 0.83 |
| EPA + DPA + | 13.20 | 10.39 | 5.36 | 6.45 |
| DHA | | | | |

The oils were subjected to OSI testing at 80° C. and at 110° C. at as set forth above. The OSI values at 80° C. and at 110° C. were measured with and/or without added tertiary-butylhydroquinone (“TBHQ”; 0.02 wt %) as indicated in Tables 3B and 3C. The results of the OSI tests are set forth in Tables 3B and 3C.

TABLE 3B
OSI at 80° C. with and without Antioxidant

| | OSI | |
|---|---|---|
| | without | OSI with |
| | TBHQ | TBHQ |
| Oil Sample | (Hours) | (Hours) |
| DHA/EPA Canola 10 | 49.51 | 73.84 |

TABLE 3C
OSI at 110° C. with and without Antioxidant

| | OSI | |
|---|---|---|
| | without | OSI with |
| | TBHQ | TBHQ |
| Oil Sample | (Hours) | (Hours) |
| CV80 | 20.16 | 52 |
| DHA/EPA Canola 13 | 7.94 | — |
| DHA/EPA Canola 10 | 5.23 | 8.21 |

These results show that the OSI values at both 80° C. and 110° C. for the oils tested are higher when TBHQ is added to the oil.

### Example 4

### Breads Prepared with Canola Oils

Three bread doughs were prepared using the ingredients listed in Table 4A and three different oils: Dough 1—canola oil (Cargill, Incorporated, Wayzata, Minn., USA); Dough 2—a canola oil including about 10 wt % combined DHA, EPA, and DPA (“DHA/EPA canola 10” from Example 3); and Dough 3—a canola oil including about 13 wt % combined DHA, EPA, and DPA (“DHA/EPA canola 13” from Example 3).

TABLE 4A
Bread Dough Dry Ingredients and Water

| Ingredient | Weight (g) |
|---|---|
| White flour | 1665.3 |
| Sugar | 51.3 |
| Salt | 10.4 |
| Dry yeast | 20 |
| Water | 1009 |

The ingredients listed in Table 4A were combined and mixed in a KITCHENAID Professional 6 mixer (Whirlpool Corporation, Benton Harbor, Mich., USA) at speed 2 for 15 minutes to form a mixture. For Dough 1, to a portion of the mixture was added canola oil (50 g oil/900 g mixture) and the combination was mixed for an additional 10 minutes at speed 2. For Dough 2, to a portion of the mixture was added DHA/EPA canola 10 oil (50 g oil/900 g mixture) and the combination was mixed for an additional 10 minutes at speed 2. For Dough 3, to a portion of the mixture was added DHA/EPA canola 13 oil (50 g oil/900 g mixture) and the combination was mixed for an additional 10 minutes at speed 2. The doughs were covered and allowed to rise for about one hour. The doughs were then punched, shaped, and placed in separate greased baking pans. The doughs were allowed to rise in the baking pans for about 30 minutes and were then placed in an oven heated to 350° F. for about 30 minutes. Each bread type was baked separately for independent aroma evaluation.

The resulting baked breads were removed from the oven and allowed to cool to room temperature and then were weighed. Characteristics of the baked doughs are summarized in Table 10B.

TABLE 4B
Characteristics of Baked Doughs

| | Baked | | | |
|---|---|---|---|---|
| | Loaf | | | |
| Sample | weight (g) | Room Aroma | Oven Aroma | Bread Sensory |
| Dough 1 | 818.3 | Strong baked- | Strong baked - | Strong baked - |
| | | bread aroma | bread aroma | bread aroma |
| Dough 2 | 832.4 | Strong baked- | Strong baked - | Strong baked - |
| | | bread aroma | bread aroma | bread aroma |
| Dough 3 | 821.7 | Strong baked- | Strong baked - | Strong baked - |
| | | bread aroma | bread aroma | bread aroma |

As shown in Table 4B, all of the dough samples had a strong baked-bread aroma after baking, no odor of paint, fish, or oxidized oil smell was detected in the baking room, in the baking oven, or emanating from the breads.

The fatty acid profiles of the baked doughs prepared in this Example were measured as follows: Oil was extracted from portions of the baked loaves (10 g) with isooctane (100 mL). The isooctane was subjected to centrifugation to separate the liquid and solid phases, and in accordance with a modified version of American Oil Chemist's Society Official Method AOCS Ce 2-66, aliquots of isooctane including extracted oils (10 mL) are treated to convert acylglycerols to fatty acid methyl esters (“FAMEs”) and vials of the FAMEs are placed in a gas chromatograph for analysis in accordance with American Oil Chemist's Society Official Method AOCS Ce 1h-05. This chromatography employs an Agilent 7890A gas chromatograph (Agilent Technologies, Santa Clara, Calif.) equipped with a fused silica capillary column (100 m×0.25 mm and 0.20 μm film thickness) packed with non-bonded, polybiscyanopropyl siloxane (Supelco Analytical, Bellefonte, Pa.). Hydrogen (H₂) is used as the carrier gas at a flow rate of 1.0 mL/min and the column temperature is isothermal at 180° C.

TABLE 4C
Fatty Acid Profile of Oils Extracted from Baked Doughs

| | Dough 1 | Dough 2 | Dough 3 |
|---|---|---|---|
| Fatty Acid | Bread | Bread | Bread |
| C8:0 | 0 | 0 | 0 |
| C9:0 | 0 | 0 | 0 |
| C10:00 | 0 | 0 | 0 |
| C11:0 | 0 | 0 | 0 |
| C12:0 | 0 | 0 | 0 |
| C11:1 | 0 | 0 | 0 |
| C13:0 | 0 | 0 | 0 |
| C12:1 | 0 | 0 | 0 |
| C14:0 | 0 | 0 | 0 |
| C13:1 | 0 | 0 | 0 |
| C14:1 + 15:0 | 0 | 0 | 0 |
| C16:0 | 4.484271 | 5.646789 | 5.662874 |
| C16:1 | 0.222448 | 0 | 0.215105 |
| C17:0 | 0 | 0 | 0 |
| C18:0 | 1.876668 | 3.16139 | 2.009315 |
| C18:1 Oleate | 60.518212 | 23.875899 | 29.623825 |
| C18:1 | 3.261889 | 2.094473 | 3.294692 |
| Vaccenate | | | |
| C18:2 | 24.412832 | 32.510157 | 32.688521 |
| C20:0 | 0.630761 | 0.82313 | 0.578346 |
| C18:3 Gamma | 0.16415 | 1.424666 | 0.987884 |
| C20:1 | 1.332181 | 0.834509 | 0.864559 |
| C18:3 Alpha | 3.096588 | 4.356737 | 7.39956 |
| Lin | | | |
| C20:2 | 0 | 0.822363 | 0.672539 |
| C22:0 | 0 | 0.380723 | 0.274916 |
| C20:3 Homo | 0 | 2.834499 | 1.235047 |
| Lin | | | |
| C22:1 | 0 | 0.282055 | 0 |
| C18:3 | 0 | 0 | 0 |
| 11:14:17 | | | |
| C20:4 | 0 | 4.60582 | 3.895987 |
| C23:0 | 0 | 0 | 0 |
| C22:2 | 0 | 0.137296 | 0 |
| C20:5 (EPA) | 0 | 7.423174 | 5.244471 |
| C24:0 | 0 | 0.530899 | 0 |
| C22:3 | 0 | 0 | 0 |
| C24:1 | 0 | 0 | 0 |
| C22:4 | 0 | 1.024137 | 0.706426 |
| C22:5N3 | 0 | 2.926645 | 3.115924 |
| (DPA) | | | |
| C22:6 (DHA) | 0 | 1.338008 | 0.67773 |

As shown in Table 4C, the baked breads made with doughs including DHA/EPA canola 10 oil and DHA/EPA canola 13 oil contain DHA, EPA, and DPA, VLC Omega-3 PUFAs. Surprisingly, as shown in Table 4B, the baked breads including DHA/EPA canola 10 oil and DHA/EPA canola 13 oil had the same favorable “strong baked-bread aroma” as the bread prepared with canola oil that did not include VLC Omega-3 PUFAs.

Breads prepared according to the methods of this Example have an estimated product shelf life of at least about 21 days at 22° C. Surprisingly, the white bread samples including DHA/EPA canola 10 oil and DHA/EPA canola 13 oil did not exhibit off aromas, e.g., painty, fishy, or oxidized oil aroma, and were comparable to bread prepared with canola oil that did not include VLC Omega-3 PUFAs during shelf life tests conducted at ambient temperature (about 22° C.) for 21 days.

### Example 5

### OSI Values of CV80 and D16EPA Canola Oil Blends

CLEAR VALLEY 80-brand canola oil (“CV80” in Table 5A) was combined with varying amounts of a canola oil including 16% EPA (“D16EPA”), as set forth in Table 5A. The OSI value at 110° C. for each of these blends was measured without any added antioxidants. The results of the OSI tests are set forth in Table 5B.

TABLE 5A
CV80 and D16EPA Canola Oil Blends

| | | D16EPA | D16EPA | CV80 | | |
|---|---|---|---|---|---|---|
| Sample | CV80 % | % | (g) | (g) | Total g | EPA % |
| 1 | 0 | 100 | 100 | 0 | 100 | 16 |
| 2 | 25 | 75 | 37.50 | 12.98 | 50.48 | 12 |
| 3 | 50 | 50 | 25.50 | 24.50 | 50.00 | 8 |
| 4 | 60 | 40 | 20.07 | 30.22 | 50.29 | 6.4 |
| 6 | 70 | 30 | 15.33 | 34.76 | 50.09 | 4.8 |
| 7 | 75 | 25 | 12.57 | 38.53 | 51.10 | 4 |
| 8 | 80 | 20 | 10.09 | 40.96 | 51.05 | 3.2 |
| 9 | 85 | 15 | 7.58 | 42.59 | 50.17 | 2.4 |
| 10 | 90 | 10 | 5.15 | 45.00 | 50.15 | 1.6 |
| CV80 | 100 | 0 | 0 | 100 | 100 | 0 |

TABLE 5B
OSI Test at 110° C. Results for CV80 and D16EPA Blends

| Sample | OSI (Hours) | Average OSI (Hours) |
|---|---|---|
| 1 | 1.86 | |
| 1 | 2.61 | 2.24 |
| 2 | | |
| 2 | 4.00 | 4.00 |
| 3 | 5.96 | |
| 3 | 6.14 | 6.05 |
| 4 | 7.34 | |
| 4 | 7.38 | 7.36 |
| 6 | 9.00 | |
| 6 | 9.19 | 9.10 |
| 7 | 10.38 | |
| 7 | 10.48 | 10.43 |
| 8 | 11.73 | |
| 8 | 11.73 | 11.73 |
| 9 | 12.87 | |
| 9 | 13.15 | 13.01 |
| 10 | 14.78 | |
| 10 | 14.84 | 14.81 |
| CV80 | 21.46 | |
| CV80 | 21.69 | 21.58 |

### Example 6

### Food Products Including DHA/EPA Canola10 and DHA/EPA Canola13 Bars

Fruit and nut bars were prepared using the ingredients listed in Table 6A. For each bar, one of three different oils was used: pressed canola oil with maximum 3.5% α-linolenic acid (“Pressed Canola Oil”; Cargill, Incorporated, Wayzata. Minn., USA); DHA/EPA canola 10 from Example 3; and DHA/EPA canola 13 from Example 3.

6A. Fruit and Nut Bar Ingredients

| Ingredients | % | g | g |
|---|---|---|---|
| Dry Ingredients: | | | |
| Crisp Rice | 8.67 | 8.50 | 107.70 |
| Raisins | 8.41 | 8.30 | 105.17 |
| Almonds | 11.15 | 11.00 | 139.38 |
| Sunflower Seeds | 1.52 | 1.50 | 19.01 |
| Currents | 1.52 | 1.50 | 19.01 |
| Total | 31.22 | 30.80 | 390.27 |
| Binder Ingredients | | | |
| Corn Syrup | 16.22 | 16.00 | 202.74 |
| Honey | 6.79 | 6.70 | 84.90 |
| Sugar | 8.11 | 8.00 | 101.37 |
| Oil | 2.13 | 2.10 | 26.61 |
| Salt | 0.51 | 0.50 | 6.34 |
| Vanilla Extract | 0.46 | 0.45 | 5.70 |
| Baking Soda | 0.10 | 0.10 | 1.27 |
| Total | 34.32 | 33.85 | 428.93 |

### Preparation Process:

1. Mix dry ingredients together in a bowl.
2. Heat binder ingredients (except vanilla extract) in a pot to 160° F. (Use a small stainless pot inside a larger stainless pot filled with boiling water.)
3. Add vanilla extract to binder ingredients and mix to incorporate.
4. Combine binder and dry ingredients.
5. Mix until well incorporated.
6. Sheet onto bar pan and roll with rolling pin until compressed.

Stability Testing:

The bars were subjected to stability testing at 22° C., 40° C., and 60° C. as follows: bars were individually packaged in foil packaging (industry typical) and placed in chambers heated to 22° C. 40° C., and 60° C., without light and humidity control. For testing, the samples were taken from the chambers, conditioned to room temperature for 2 hours, then evaluated by an expert panel (n=3). Sensory panelists use a 10-point scale (pass/fail; 1 is the lowest score) where a score of 10 is a clean/bland aroma and pass, a score of 7 is the minimum score to pass, and a score of less than 7 is fail and provide comments describing off notes or positive attributes of the sample tested. Time points for different temperatures: for 22° C. samples were evaluated monthly, at 40° C. samples were evaluated weekly, and at 60° C. samples were evaluated every three days.

Sample tests at 22° C. represent real-time shelf life determinations, whereas accelerated temperature tests at 40° C. and 60° C. allow for the estimation of longer shelf life at ambient temperatures. For example, one day of sample storage at 40° C. corresponds to about 2.5 days of sample storage at 22° C., and one day of sample storage at 60° C. corresponds to about 30 days of sample storage at 22° C.

Results of the sensory panel data for bar samples subjected to accelerated stability testing at 40° C. are summarized in Table 6B. Results of the sensory panel data for bar samples subjected to accelerated stability testing at 60° C. are summarized in Table 6C.

6B. Fruit and Nut Bars Accelerated Stability
Testing 40° C. Sensory Panel Data

| Oil type | Time 0 | Week 1 | Week 2 | Week 3 | Week 4 |
|---|---|---|---|---|---|
| Pressed | Pass 8/10 | Pass 7/10 | Pass 7/10 | Pass 7/10 | Pass 7/10 |
| Canola Oil | | | | | |
| DHA/EPA | Pass 10/10 | Pass 7/10 | Pass 7/10 | Pass 7/10 | Pass 7/10 |
| Canola 10 | | Earthy, | | | |
| | | Cardboard | | | |
| DHA/EPA | Pass 9/10 | Pass 10/10 | Pass 8/10 | Pass 7/10 | Fail 1/10 |
| Canola 10 | | | | | Rancid |
| with Anti- | | | | | |
| oxidant* | | | | | |
| DHA/EPA | Pass 10/10 | Pass 10/10 | Pass 8/10 | Fail 4/10 | Fail 1/10 |
| Canola 13 | | | Slightly | Rancid | Rancid |
| | | | earthy | | |
| DHA/EPA | Pass 10/10 | Pass 9/10 | Pass 9/10 | Fail 6/10 | Fail 1/10 |
| Canola 13 | | Earthy | | Rancid | Rancid |
| with Anti- | | | | | |
| oxidant* | | | | | |

*Rosemary/citric acid antioxidant blend, about 0.1 g antioxidant/30.0 g oil

6C. Fruit and Nut Bars Accelerated Stability Testing 60° C. Sensory Panel Data

| Oil type | Day 0 | Day 3 | Day 6 | Day 9 | Day 12 |
|---|---|---|---|---|---|
| Pressed | Pass 8/10 | Pass 8/10 | Pass 8/10 | Pass 8/10 | Pass 8/10 |
| Canola Oil | | | | | |
| DHA/EPA | Pass 10/10 | Pass 8/10 | Pass 8/10 | Fail 4/10 | Fail |
| Canola 10 | | | | Comments: | |
| | | | | Rancid | |
| DHA/EPA | Pass 9/10 | Pass 7/10 | Fail 4/10 | Fail 1/10 | Fail |
| Canola 10 with | | Comments: | Comments: | Comments: | |
| Antioxidant* | | Slightly earthy | Rancid/Fishy | Rancid | |
| DHA/EPA | Pass 10/10 | Pass 9/10 | Fail 2/10 | Fail | Fail |
| Canola 13 | | | Comments; | | |
| | | | Rancid | | |
| DHA/EPA, | Pass 10/10 | Pass 8/10 | Fail 4/10 | Fail | Fail |
| Canola 13 with | | | Comments: | | |
| Antioxidant* | | | Rancid | | |

*Rosemary/citric acid antioxidant blend, about 0.1 g antioxidant/30.0 g oil

As the data show, bars prepared using DHA/EPA Canola 10 and DHA/EPA Canola 13 showed surprising stability. This is significant because oil products that are currently commercially available typically require sealed freezer or refrigeration storage or double encapsulation for stability. This Example demonstrates that a DHA/EPA canola oil can provide satisfactory sensory performance without encapsulation or lower temperatures when used as an oil as well as when used as an ingredient in food applications.

### Crackers

KROGER THIN AND CRISPY SALTINES (Kroger Co., Cincinnati, Ohio, USA) were sprayed with various oils and subjected to accelerated stability testing.

Method of coating crackers with oil:
1. Use unsalted crackers-300 grams crackers/per batch-approximately 94 crackers.
2. Line crackers on table over plastic wrap.
3. Measure oil into small sprayer bottle (about 30 grams oil).
   (Note: measured treatments into spray bottles flushed with N₂ and stored in refrigerator until use.)
4. Put spray bottles with oil into 40° C. oven until warm to help disperse oil droplets.
5. Spray crackers with oil.
6. Allow crackers to air dry for at least 30 minutes.
7. Store treated crackers in refrigerator at 4° C. in Corning Ware, crackers stacked inside.

Stability Testing:

Crackers were placed in amber bottles for 60° C. tests and in foil packages (industry typical) for ambient temperature testing at 22° C. The test were conducted without light and humidity control. For testing, the samples were taken from the chambers, conditioned to room temperature for 2 hours, then evaluated by an expert panel (n=3). Sensory panelists use a 10-point scale (pass/fail; 1 is the lowest score) where a score of 10 is a clean/bland aroma and pass, a score of 7 is the minimum score to pass, and a score of less than 7 is fail and provide comments describing off notes or positive attributes of the sample tested. Time points for different temperatures: for 22° C. samples were evaluated monthly and at 60° C. samples were evaluated every three days.

Sample tests at 22° C. represent real-time shelf life determinations, whereas accelerated temperature tests 60° C. allow for the estimation of longer shelf life at ambient temperatures. For example, one day of sample storage at 60° C. corresponds to about 30 days of sample storage at 22° C.

The following oils and oil blends were used to prepare sprayed cracker applications: MASTER CHEF Soybean Oil (Cargill, Incorporated, Wayzata, Minn., USA), DHA/EPA Canola 10 from Example 3, DHA/EPA Canola 13 from Example 3, and a pressed canola oil with maximum 3.5% α-linolenic acid (“Pressed Canola Oil”; Cargill, Incorporated, Wayzata, Minn., USA). Weights of crackers and oils for sample preparation are shown in Table 6D.

6D. Weights of Crackers and Sprayed Oil:

| Oil | Crackers (g) | Oil (g) |
|---|---|---|
| Soybean | 300.1 | 30.0 |
| DHA/EPA Canola 10 | 300.1 | 30.0 |
| Pressed Canola Oil | 299.7 | 30.0 |
| DHA/EPA Canola 13 | 302.5 | 30.1 |
| DHA/EPA Canola 13 | 302.1 | 30.0 |
| with Antioxidant* | | |
| DHA/EPA Canola 10 | 300.5 | 30.0 |
| with Antioxidant* | | |
| Pressed Canola Oil | 301.9 | 30.0 |
| with Antioxidant* | | |

*Approximately 0.3 wt % rosemary/citric acid antioxidant blend in oil

Results of the sensory panel data for cracker samples subjected to accelerated stability testing at 60° C. are summarized in Table 6E.

6 E. Crackers Accelerated Stability Testing 60° C. Sensory Panel Data

| | | | | | |
|---|---|---|---|---|---|
| OIL | Day 0 | Day 3 | Day 6 | Day 9 | Day 12 |

| | | | | |
|---|---|---|---|---|
| Pressed Canola Oil | Strong Crude | Less intense | Slight | Oxidized - |
| | oil smell - PASS | Crude oil | Oxidation - PASS | FA1L |
| | | smell - PASS | | |
| Pressed Canola Oil | Strong Crude | Grassy but less | Some Rosemary | Oxidized - |
| with Antioxidant* | oil smell - PASS | intense than | Aromas - PASS | FAIL |
| | | day 0 - PASS | | |
| DHA/EPA Canola 10 | Strong Crude | Strong Fish Smell/ | | |
| | oil smell - PASS | Oxidation - FAIL | | |
| DHA/EPA Canola 10 | Strong Crude | Slight fish | Strong Fish Smell/ | |
| with Antioxidant* | oil smell - PASS | Aroma - PASS | Oxidation - FAIL | |
| DHA/EPA Canola 13 | Strong Crude | Strong Fish | | |
| | oil smell - PASS | Smell - FAIL | | |
| DHA/EPA Canola 13 | Strong Crude | Slight Fish | Strong Fish | |
| with Antioxidant* | oil smell - PASS | Aroma - PASS | Smell - FAIL | |

*Approximately 0.3 wt % rosemary/citric acid antioxidant blend in oil

As the data show, crackers prepared using DHA/EPA Canola 10 and DHA/EPA Canola 13 demonstrate surprising stability.

### Ready-to-Eat Cereal

CHEERIOS ready-to-eat cereal (General Mills Inc., Minneapolis, Minn., USA) is coated with various oils and subjected to accelerated stability testing. For CHEERIOS sample, one of three different oils was used: pressed canola oil with maximum 3.5% α-linolenic acid (“Pressed Canola Oil”; Cargill, Incorporated, Wayzata, Minn., USA): DHA/EPA canola 10 from Example 3; and DHA/EPA canola 13 from Example 3.

Method of Coating Ready-to-Eat Cereal:
1. Weigh 300 grams of CHEERIOS ready-to-eat cereal.
2. Measure oil into small sprayer bottle (about 30 grams oil).
(Note: measured treatments into spray bottles flushed with N₂ and stored in refrigerator until use.)
3. Put spray bottles with oil into 40° C. oven until warm to help disperse oil droplets.
4. Put CHEERIOS into Vanguard mixer (set at 28.2 r/min), spray oil into mixer until thoroughly mixed.

Stability Testing:

CHEERIOS were placed in amber bottles for 60° C. tests and in foil packages (industry typical) for ambient temperature testing at 22° C. The test were conducted without light and humidity control. For testing, the samples were taken from the chambers, conditioned to room temperature for 2 hours, then evaluated by an expert panel (n=3). Sensory panelists use a 10-point scale (pass/fail; 1 is the lowest score) where a score of 10 is a clean/bland aroma and pass, a score of 7 is the minimum score to pass, and a score of less than 7 is fail and provide comments describing off notes or positive attributes of the sample tested. Time points for different temperatures: for 22° C. samples were evaluated monthly and at 60° C. samples were evaluated every three days.

Sample tests at 22° C. represent real-time shelf life determinations, whereas accelerated temperature tests 60° C. allow for the estimation of longer shelf life at ambient temperatures. For example, one day of sample storage at 60° C. corresponds to about 30 days of sample storage at 22° C.

Weights of CHEERIOS and oils for sample preparation are shown in Table 6F.

TABLE 6F
Weights of CHEERIOS and Sprayed Oil:

| Oil | CHEERIOS (g) | Oil (g) |
|---|---|---|
| DHA/EPA Canola 10 | 299.9 | 30.01 |
| with Antioxidant* | | |
| DHA/EPA Canola 10 | 300.2 | 30 |
| with Antioxidant* | | |
| Pressed Canola Oil | 300.1 | 30.02 |
| with Antioxidant* | | |
| DHA/EPA Canola 10 | 299.9 | 30 |
| DHA/EPA Canola 13 | 300.2 | 30.03 |
| Pressed Canola Oil | 300 | 30.0 |

*Approximately 0.3 wt % rosemary/citric acid antioxidant blend in oil.

Results of the sensory panel data for CHEERIOS cereal samples subjected to accelerated stability testing at 60° C. are summarized in Table 60.

TABLE 6G
CHEERIOS Accelerated Stability Testing 60° C. Sensory Panel Data

| Oil type | Day 0 | Day 3 | Day 6 | Day 9 | Day 12 |
|---|---|---|---|---|---|
| Pressed Canola Oil | Pass | Pass | Pass | Pass | Pass Earthy |
| | | | | | cardboard aroma |
| Pressed Canola Oil | Pass | Pass | Pass | Pass | Pass |
| with Antioxidant | | | | | |
| DHA/EPA Canola 10 | Pass | Fail Fishy | Fail Rancid | Fail | Fail |
| DHA/EPA Canola 10 | Pass | Pass Low | Fail Fishy/ | Fail Rancid | Fail |
| with Antioxidant | | Green No Crude | Painty | | |
| DHA/EPA Canola 13 | Pass | Fail Fishy | Fail Rancid | Fail | Fail |
| DHA/EPA Canola 13 | Pass | Pass Slightly | Fail Fishy | Fail Rancid | Fail |
| with Antioxidant | | Fishy | | | |

As the data show, ready-to-eat cereal prepared using DHA/EPA canola 10 and DHA/EPA canola 13 demonstrate surprising stability.

### Muffins

Muffin mix was prepared using the ingredients listed in Table 6H. For each batch of muffins, one of two different oils was used: pressed canola oil with maximum 3.5% α-linolenic acid (“Pressed Canola Oil”; Cargill, Incorporated, Wayzata, Minn., USA) and DHA/EPA canola 10 from Example 3.

TABLE 6H
Muffin Recipe

| Ingredients | grams |
|---|---|
| CLEAR VALLEY | 339.6 |
| all-purpose shortening | |
| Sugar | 766.3 |
| Salt | 7.5 |
| Large Eggs | 8 total |
| Vanilla extract | 5.0 |
| Self rising flour | 473.1 |
| All purpose flour | 362.0 |
| Milk | 446.2 |

### Method of Preparing Muffins:

1. Cream shortening on setting 2 for 5 minutes with a KITCHENAID Professional 6 mixer (Whirlpool Corporation, Benton Harbor, Mich., USA).
2. Add salt while stirring.
3. Add eggs one by one and vanilla.
4. Mix flours together in bowl.
5. Add ½ of mixed flour and ½ of milk.
6. Add remaining flour and milk to mix and stir for a total of 4 minutes.
7. Split muffin mix into four batches of about 600 grams.
8. Add oil (about 28 g) to muffin mix batch (600 g) and mix using a KITCHENAID Professional 6 mixer (Whirlpool Corporation, Benton Harbor, Mich., USA).
9. Divide batter into 12 muffins (into paper-lined muffin wrap in muffin tin).
10. Bake muffins at 350° F. for about 22 minutes.

The DHA+EPA content in the food products prepared as described above is shown in Table 6I.

TABLE 6I
DHA and EPA Content in Example 6 Food Products

| | | DHA + EPA (mg) | DHA + EPA (mg) |
|---|---|---|---|
| | Serving size | DHA/EPA | DHA/EPA |
| Product | (g) | CANOLA10 | CANOLA13 |
| Bars | 40 | 90.72 | 129.6 |
| Crackers | 40 | 280 | 400 |
| CHEERIOS | 28 | 196 | 280 |
| Muffins | 55 | 154 | 220 |

Estimates of food product shelf lives for food products prepared in Example 6 are listed in table 6J.

6J. Estimated Food Product Shelf Life

| | | |
|---|---|---|
| | | DHA + EPA |
| | DHA + EPA | canola oil with |
| Product | canola oil | Rosemary/Ascorbic Acid |

| | | | | |
|---|---|---|---|---|
| Fruit and Nut Bars | 6 | mo | 3 | mo |
| Cereal | 1 | mo | 3 | mo |
| Crackers | 1 | mo | 3 | mo |
| White Bread | 21 | day | 21 | day |
| Muffins | 21 | day | 21 | day |

### SUMMARY

DHA+EPA canola oil can deliver at least six months shelf stability at ambient temperature without antioxidant added in a Fruit and Nut Bars application.

DHA+EPA canola oil can deliver at least one month shelf stability at ambient temperature without AO added in crackers and cereal applications.

Oxidation stability and sensory performance of DHA+EPA canola oil can be improved by addition of a rosemary/ascorbic acid antioxidant blend to the oil and can deliver at least three months of shelf stability at ambient temperature in crackers and cereal applications.

DHA+EPA canola oil with or without rosemary/ascorbic acid antioxidant blend can be used as ingredient for bakery applications (for example, breads and muffins) and deliver typical (i.e., 21 day) product shelf stability at ambient temperature.

### Example 7

### Beverages Including DHA/EPA Canola Oil

### Milk-Based Beverages

Milk-based beverages are prepared using commercially-available milk, including: a whole milk, a 2% reduced-fat milk, a 1% reduced-fat milk, and a skimmed milk (“fat-free” milk). Three different oils are combined with the milk samples to form milk-based beverages: CLEAR VALLEY 80-brand (“CV80”) canola oil (Cargill, Incorporated, Wayzata, Minn., USA); a canola oil including about 9.6 wt % combined DHA, EPA, and DPA (“DHA/EPA canola 9”); and DHA/EPA canola 9 including about 3,000 ppm of a rosemary/citric acid antioxidant blend (“DAH/EPA canola 9R”).

Preparation of Milk-Based Beverages: Oil is added to a milk sample followed by mixing for about 15 minutes with a Waring Heavy Duty Food Blender (Conair Corporation, East Windsor, N.J., USA) on the highest setting to provide a milk-based beverage. For oils that include DHA and EPA, sufficient oil is added to the milk sample such that the milk-based beverage includes greater than 32 mg/serving DHA+EPA. The milk-based beverage is heated at about 140° F. (about 60° C.) and is subjected to sonication at about 2,500 psi in a Qsonica sonicator (Qsonica, LLC, Newtown, Conn., USA). The milk-based beverage is heated to about 190° F. (about 88° C.) and held at that temperature for about 90 seconds. The milk-based beverage is allowed to cool to about 55° F. (about 13° C.). The cooled milk-based beverage is transferred aseptically to sterilized amber bottle which are stored under refrigeration at 4° C.

The milk-based beverages are tested by an expert panel (n=4) for aroma, with a focus on painty and fishy notes, immediately following preparation (“Time 0”) and after one week of storage at 4° C. (“Time 1 Week”). Sensory panelists use a 10-point scale (1 is the lowest score) where a score of 10 is a clean milk aroma and pass, a score of 7 is the minimum score to pass, and a score of less than 7 is fail.

Results of the sensory panel data for milk-based beverages are summarized in Tables 7A and 7B.

7A. Sensory Panel Results for Milk-Based Beverages at Time 0

| | Whole | 2% Fat | 1% Fat | Fat-Free |
|---|---|---|---|---|
| | Milk | Milk | Milk | Milk |
| | Aroma | Aroma | Aroma | Aroma |
| | Score | Score | Score | Score |
| No oil added | 9 | 9 | 9 | 9 |
| CV80 | 9 | 9 | 9 | 9 |
| DHA/EPA Canola 9 | 8.5 | 7.5 | 8.5 | 8 |
| DHA/EPA Canola 9R | 8.5 | 7.5 | 8 | 7 |

7B. Sensory Panel Results for Milk-
Based Beverages at Time 1 Week

| | Whole | 2% Fat | 1% Fat | Fat-Free- |
|---|---|---|---|---|
| | Milk | Milk | milk | Milk |
| | Aroma | Aroma | Aroma | Aroma |
| | Score | Score | Score | Score |
| No oil added | 10 | 10 | 10 | 8.5 |
| CV80 | 10 | 10 | 9.5 | 10 |
| DHA/EPA Canola 9 | 8 | 8 | 8 | 7.5 |
| DHA/EPA Canola 9R | 7.5 | 7.5 | 75 | 7 |

As the data in Tables 7A and 7B show, DHA+EPA canola oil, either with or without added antioxidant, can deliver at least one week stability at 4° C. when used in a milk-based beverage.

### Chocolate-Flavored Milk-Based Beverage

Chocolate-flavored milk-based beverages are prepared using the formulations in Table 7C with oils as described above for milk-based beverages. For formulations having oils that include DHA and EPA, sufficient oil is added to the milk such that the milk beverage includes greater than 32 mg/serving DHA+EPA.

TABLE 7C
Chocolate-Flavored Milk-Based Beverage Formulations

| | No oil | | DHA/EPA | DHA/EPA |
|---|---|---|---|---|
| Formulation | added | CV80 | Canola 9 | Canola 9R |
| Skimmed milk (g) | 226.464 | 224.34 | 224.34 | 224.34 |
| Sugar, granulated (g) | 10.8 | 10.8 | 10.8 | 10.8 |
| AUBYGEL | 0.072 | 0.072 | 0.072 | 0.072 |
| carageenan, (g) | | | | |
| SANALAC non-fat | 1.272 | 1.272 | 1.272 | 1.272 |
| dried milk (g) | | | | |
| DHA/EPA Canola 9 (g) | 0 | 0 | 0.52 | 0 |
| DHA/EPA Canola 9R (g) | 0 | 0 | 0 | 0.52 |
| CV80 (g) | 0 | 2.124 | 1.604 | 1.604 |
| Cocoa powder mix (g) | 1.1712 | 1.1712 | 1.1712 | 1.1712 |
| Sodium chloride (g) | 0.2088 | 0.2088 | 0.2088 | 0.2088 |
| Natural vanillin (g) | 0.012 | 0.012 | 0.012 | 0.012 |
| TOTALS (g) | 240.0 | 240.0 | 240.0 | 240.0 |

Preparation of Chocolate-Flavored Milk-Based Beverages:

Milk is weighed and placed in a container. To the milk is added AUBYGEL carrageenan (Cargill, Incorporated, Wayzata, Minn., USA) with stirring to provide a milk mixture. The granulated sugar (Cargill, Incorporated, Wayzata, Minn., USA), SANALAC non-fat dried milk (Saco Foods Inc., Middleton, Wis., USA), cocoa powder mix (Cargill, Incorporated, Wayzata, Minn., USA), and sodium chloride (Cargill, Incorporated, Wayzata, Minn., USA) are combined with mixing to provide a dry ingredients mixture. The dry ingredients mixture is added to the milk mixture with stirring for about 15 minutes with a Waring Heavy Duty Food Blender (Conair Corporation, East Windsor, N.J., USA) on the lowest setting to provide a blended mixture. To the blended mixture is added the oil and natural vanillin (Kerry Group Plc, Ireland) followed by mixing for about 15 minutes with a Waring Heavy Duty Food Blender (Conair Corporation, East Windsor, N.J., USA) on the highest setting to provide a chocolate-flavored milk-based beverage. The chocolate-flavored milk-based beverage is heated to about 190° F. (about 88° C.) and held at that temperature for about 90 seconds. The chocolate-flavored milk-based beverage is allowed to cool to about 55° F. (about 13° C.). The cooled mixture is transferred aseptically to sterilized amber bottle which are stored under refrigeration at 4° C.

The chocolate-flavored milk-based beverages are tested by an expert panel (n=4) for aroma, with a focus on painty and fishy notes, immediately following preparation (“Time 0”) and after one week of storage at 4° C. (“Time 1 Week”). Sensory panelists use a 10-point scale (1 is the lowest score) where a score of 10 is a clean chocolate milk aroma and pass, a score of 7 is the minimum score to pass, and a score of less than 7 is fail.

Results of the sensory panel data for chocolate-flavored milk-based beverages are summarized in Table 7D.

7D. Sensory Panel Results for Chocolate-Flavored
Milk-Based Beverages at Time 0 and Time 1 Week

| | Time 0 | Time 1 Week |
|---|---|---|
| | Aroma Score | Aroma Score |
| No oil added | 9 | 9.5 |
| CV80 | 9.75 | 10 |
| DHA/EPA Canola 9 | 8.5 | 8.5 |
| DHA/EPA Canola 9R | 8.25 | 9 |

As the data in Table 7D show, DHA+EPA canola oil, either with or without added antioxidant, can deliver at least one week stability at 4° C. when used in a chocolate milk beverage.

### Meal Replacement/Supplement Beverage

Meal replacement/supplement beverages are prepared using the formulations in Table 7E and oils as described above for milk-based beverages. For formulations having oils that include DHA and EPA, sufficient oil is added to the beverage such that the beverage includes greater than 32 mg/serving DHA+EPA.

TABLE 7E
Meal Replacement/Supplement Beverage Formulations

| | | DHA/EPA | DHA/EPA |
|---|---|---|---|
| | CV80 | Canola 9 | Canola 9R |
| Batch water (g) | 169.520 | 169.499 | 169.499 |
| Water for carrageenan (170° F.) (g) | 26.000 | 26.000 | 26.000 |
| AUBYGEL carrageenan (g) | 0.117 | 0.117 | 0.117 |
| Sugar, granulated (g) | 24.700 | 24.700 | 24.700 |
| Corn syrup solids (20 DE) (g) | 20.280 | 20.280 | 20.280 |
| Milk protein concentrate (g) | 12.220 | 12.220 | 12.220 |
| CV80 (g) | 5.486 | 4.924 | 4.924 |
| DHA/EPA Canola 9 (g) | 0.000 | 0.582 | 0 |
| DHA/EPA Canola 9R (g) | 0.000 | 0 | 0.582 |
| Lecithin (g) | 0.117 | 0.117 | 0.117 |
| FORTITECH vitamin mineral | 0.780 | 0.780 | 0.780 |
| pre-mix (g) | | | |
| Natural vanilla flavor (g) | 0.780 | 0.780 | 0.780 |
| Total (g) | 260.00 | 260.00 | 260.00 |

Preparation of Meal Replacement/Supplement Beverage:

The water for carrageenan is heated to about 170° C. The AUBYGEL carrageenan (Cargill, Incorporated. Wayzata, Minn., USA) is added to the heated water with stirring for about 15 minutes in a Waring Heavy Duty Food Blender (Conair Corporation. East Windsor, N.J., USA) on the lowest setting until the carrageenan is fully hydrated. The carrageenan solution is added to the batch water with stirring for about 5 minutes until a homogeneous mixture is formed. The milk protein concentrate is added to the mixture with stirring for about 5 minutes until homogeneous. The cane sugar and corn syrup solids are then added with stirring for about 5 minutes in a Waring Heavy Duty Food Blender (Conair Corporation, East Windsor, N.J., USA) on the lowest setting. The CV80 oil is heated to about 120° F. (about 49° C.) and to the heated CV80 is added lecithin with stirring for about 5 minutes until the lecithin CV80 mixture is homogenous. The lecithin/CV80 mixture is added to the aqueous mixture with stirring for about 5 minutes in a Waring Heavy Duty Food Blender (Conair Corporation, East Windsor, N.J., USA) on the lowest setting. To the aqueous mixture is added the DHA/EPA canola oil with stirring for about 5 minutes in a Waring Heavy Duty Food Blender (Conair Corporation, East Windsor, N.J., USA) on the lowest setting. Next, the vitamin mineral pre-mix (Royal DSM, Heerlen, Netherlands) is added to the mixture with stirring for about 5 minutes in a Waring Heavy Duty Food Blender (Conair Corporation, East Windsor, N.J., USA) on the lowest setting. Finally, the vanilla flavor is added to the mixture with stirring for about 5 minutes in a Waring Heavy Duty Food Blender (Conair Corporation, East Windsor, N.J., USA) on the lowest setting to provide the meal replacement/supplement beverage.

The meal replacement/supplement beverage is heated to about 190° F. (about 88° C.) and held at that temperature for about 90 seconds. The meal replacement/supplement beverage is allowed to cool to about 55° F. (about 13° C.). The cooled meal replacement/supplement beverage is transferred aseptically to sterilized amber bottle which are stored under refrigeration at 4° C.

The meal replacement/supplement beverages are tested by an expert panel (n=4) for aroma, with a focus on painty and fishy notes, immediately following preparation (“Time 0”) and after 16 days of storage at 4° C. (“Time 16 Days”). Sensory panelists use a 10-point scale (1 is the lowest score) where a score of 10 is a clean aroma having no off-aroma notes (e.g., fishy, painty, grassy, oxidized) and pass, a score of 7 is the minimum score to pass, and a score of less than 7 is fail.

Results of the sensory panel data for the meal replacement/supplement beverages are summarized in Table 7F.

7F. Sensory Panel Results for Meal Replacement/Supplement
Beverage at Time 0 and Time 16 Days

| | Time 0 | Time 16 Days |
|---|---|---|
| | Aroma Score | Aroma Score |
| CV80 | 8.5 | 9 |
| DHA/EPA Canola 9 | 7.5 | 7 |
| DHA/EPA Canola 9R | 7 | 8 |

As the data in Table 7F show, DHA+EPA canola oil, either with or without added antioxidant, can deliver at least 16 days of stability at 4° C. when used in a meal replacement/supplement beverage.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. Although specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can also be combined to provide further embodiments.

In general, the terms used in the claims should not be construed to limit the invention to the specific embodiments disclosed in the specification, unless the above detailed description explicitly defines such terms.

What is claimed is:

1.-18. (canceled)

19. A food composition comprising:
an edible, non-hydrogenated fat having at least 1 wt % omega-3 fatty acids with a carbon chain length of twenty or greater and three or more carbon-carbon double bonds, no more than 10 wt % saturated fatty acids, and an Oxidative Stability Index (“OSI”) at 110° C. of at least 5 hours in the absence of added antioxidants,
wherein the food composition comprises at least 16 mg of EPA plus DHA per FDA reference serving size of the food composition, and wherein the food composition has no material increase in an off-flavor or an off-aroma after storage at about 60° C. for at least about 6 hours, as determined by a trained sensory panel, in comparison to a control food composition that is formed in the same manner but without the 16 mg of EPA plus DHA.

20. The food composition of claim 19, wherein the food composition is selected from the group consisting of a pasta, a cracker, a bar, or a ready-to-eat cereal.

21. The food composition of claim 19, wherein the food composition comprises at least 32 mg of EPA plus DHA per FDA reference serving size of the food composition, and wherein the food composition has no material increase in an off-flavor or an off-aroma after storage at about 60° C. for at least about 6 hours, as determined by a trained sensory panel, in comparison to a control food composition that is formed in the same manner but without the 32 mg of EPA plus DHA.

22. The food composition of claim 20, wherein the food composition comprises at least 32 mg of EPA plus DHA per FDA reference serving size of the food composition, and wherein the food composition has no material increase in an off-flavor or an off-aroma after storage at about 60° C. for at least about 6 hours, as determined by a trained sensory panel, in comparison to a control food composition that is formed in the same manner but without the 32 mg of EPA plus DHA.

23. A food composition comprising:
an edible, non-hydrogenated fat having at least 1 wt % omega-3 fatty acids with a carbon chain length of twenty or greater and three or more carbon-carbon double bonds, and an Oxidative Stability Index (“OSI”) at 110° C. of at least 37 hours,
wherein the edible, non-hydrogenated fat includes:
a) a first fat including a rapeseed oil having at least about 65 wt % oleic acid;
b) a second fat having at least 10 wt % of omega-3 fatty acids with a carbon chain length of twenty or greater and three or more carbon-carbon double bonds; and
c) optionally an antioxidant,
wherein the food composition comprises at least 16 mg of EPA plus DHA per FDA reference serving size of the food composition, and wherein the food composition has no material increase in an off-flavor or an off-aroma after storage at about 60° C. for at least about 6 hours, as determined by a trained sensory panel, in comparison to a control food composition that is formed in the same manner but without the 16 mg of EPA plus DHA.

24. The food composition of claim 23, wherein the food composition is selected from the group consisting of a pasta, a cracker, a bar, or a ready-to-cat cereal.

25. The food composition of claim 23, wherein the food composition comprises at least 32 mg of EPA plus DHA per FDA reference serving size of the food composition, and wherein the food composition has no material increase in an off-flavor or an off-aroma after storage at about 60° C. for at least about 6 hours, as determined by a trained sensory panel, in comparison to a control food composition that is formed in the same manner but without the 32 mg of EPA plus DHA.

26. The food composition of claim 24, wherein the food composition comprises at least 32 mg of EPA plus DHA per FDA reference serving size of the food composition, and wherein the food composition has no material increase in an off-flavor or an off-aroma after storage at about 60° C. for at least about 6 hours, as determined by a trained sensory panel, in comparison to a control food composition that is formed in the same manner but without the 32 mg of EPA plus DHA.

27. An edible baked food product formed by baking a composition at a temperature of at least 177° C. for at least 15 minutes,
wherein the composition includes an edible, non-hydrogenated fat comprising a) a vegetable-sourced oil containing omega-3 fatty acids with a carbon chain length of twenty or greater and three or more carbon-carbon double bonds, and b) optionally an antioxidant,
wherein the edible, non-hydrogenated fat has an Oxidative Stability Index (“OSI”) at 110° C. of at least 5 hours and at least 1 wt % omega-3 fatty acids with a carbon chain length of twenty or greater and three or more carbon-carbon double bonds, and wherein the edible baked food product comprises at least 16 mg of EPA plus DHA per FDA reference serving size of the food product, and has no material increase in an off-flavor or an off-aroma after storage at about 22° C. for at least about 12 hours, as determined by a trained sensory panel, in comparison to a control food product that is formed in the same manner but without the 16 mg of EPA plus DHA.

28. The food product of claim 27, wherein the food product is selected from the group consisting of a bread or a muffin.

29. The edible baked food product of claim 27, wherein the food product comprises at least 32 mg of EPA plus DHA per FDA reference serving size of the food product, and wherein the food product has no material increase in an off-flavor or an off-aroma after storage at about 22° C. for at least about 12 hours, as determined by a trained sensory panel, in comparison to a control food product that is formed in the same manner but without the 32 mg of EPA plus DHA.

30. An edible baked food product formed by baking a composition at a temperature of at least 177° C. for at least IS minutes,
wherein the composition includes an edible, non-hydrogenated fat comprising:
a) a rapeseed oil having at least 65 weight percent (“wt %”) oleic acid;
b) a vegetable-sourced oil containing omega-3 fatty acids with a carbon chain length of twenty or greater and three or more carbon-carbon double bonds, and
c) optionally an antioxidant,
wherein the edible, non-hydrogenated fat has an Oxidative Stability Index (“OSI”) at 110° C. of at least 37 hours and at least 1 wt % omega-3 fatty acids with a carbon chain length of twenty or greater and three or more carbon-carbon double bonds and wherein the edible baked food product comprises at least 16 mg of EPA plus DHA per FDA reference serving size of the food product, and has no material increase in an off-flavor or an off-aroma after storage at about 22° C. for at least about 12 hours, as determined by a trained sensory panel, in comparison to a control food product that is formed in the same manner but without the 16 mg of EPA plus DHA.

31. The food composition of claim 30, wherein the food product is selected from the group consisting of a bread or a muffin.

32. The edible baked food product of claim 30, wherein the food product comprises at least 32 mg of EPA plus DHA per FDA reference serving size of the food product, and wherein the food product has no material increase in an off-flavor or an off-aroma after storage at about 25° C. for at least about 12 hours, as determined by a trained sensory panel, in comparison to a control food product that is formed in the same manner but without the 32 mg of EPA plus DHA.

33. A method of making an edible baked food product, the method comprising:
mixing a composition comprising a rust food ingredient, which may be flour, and an edible, non-hydrogenated fat; and
baking the composition at a temperature of at least 350° F. (177° C.) for at least 15 minutes,
wherein the non-hydrogenated fat comprises:
a) a vegetable-sourced oil containing omega-3 fatty acids with a carbon chain length of twenty or greater and three or more carbon-carbon double bonds; and
b) optionally an antioxidant,
wherein the edible, non-hydrogenated fat has an Oxidative Stability Index (“OSI”) at 110° C. of at least 5 hours and at least 1 wt % omega-3 fatty acids with a carbon chain length of twenty or greater and three or more carbon-carbon double bonds and wherein the edible baked food product comprises at least 16 mg of EPA plus DHA per FDA reference serving size of the food product, and has no material increase in an off-flavor or an off-aroma after storage at about 22° C. for at least about 12 hours, as determined by a trained sensory panel, in comparison to a control food product that is formed in the same manner but without the 16 mg of EPA plus DHA.

34. The method of claim 33, wherein the food composition is selected from the group consisting of a bread or a muffin.

35. The method of claim 33, wherein the food product comprises at least 32 mg of EPA plus DHA per FDA reference serving size of the food product, and wherein the food product has no material increase in an off-flavor or an off-aroma after storage at about 22° C. for at least about 12 hours, as determined by a trained sensory panel, in comparison to a control food product that is formed in the same manner but without the 32 mg of EPA plus DHA.

36. A method of making an edible baked food product, the method comprising:
mixing a composition comprising a first food ingredient, which may be flour, and an edible, non-hydrogenated fat; and
baking the composition at a temperature of at least 350° F. (177° C.) for at least 15 minutes,
wherein the non-hydrogenated fat comprises:
a) a first fat including a rapeseed oil having at least about 65 wt/% oleic acid;
b) a second fat having at least 10 wt % of omega-3 fatty acids with a carbon chain length of twenty or greater and three or more carbon-carbon double bonds; and
c) optionally an antioxidant,
wherein the edible, non-hydrogenated fat has an Oxidative Stability Index (“OSI”) at 110° C. of at least 37 hours and at least 1 wt % omega-3 fatty acids with a carbon chain length of twenty or greater and three or more carbon-carbon double bonds and wherein the edible baked food product comprises at least 16 mg of EPA plus DHA per FDA reference serving size of the food product, and has no material increase in an off-flavor or an off-aroma after storage at about 22° C. for at least about 12 hours, as determined by a trained sensory panel, in comparison to a control food product that is formed in the same manner but without the 16 mg of EPA plus DHA.

37. The method of claim 36, wherein the food product is selected from the group consisting of a bread or a muffin.

38. The method of claim 36, wherein the food product comprises at least 32 mg of EPA plus DHA per FDA reference serving size of the food product, and wherein the food product has no material increase in an off-flavor or an off-aroma after storage at about 22° C. for at least about 12 hours, as determined by a trained sensory panel, in comparison to a control food product that is formed in the same manner but without the 32 mg of EPA plus DHA.
